(19) United States
(12) Patent Application Publication
(10) Pub. No.: US 2026/0292709 A1
(43) Pub. Date: Sep. 24, 2026

(54) FULL POWER TRANSMISSION SUPPORT FOR TRANSMITTER (TX) UPLINKS (ULS) IN A WIRELESS NETWORK

(71) Applicant: Apple Inc., Cupertino, CA (US)

(72) Inventors: Dan WU, Beijing (CN); Haitong SUN, Cupertino, CA (US); Wei ZENG, Saratoga, CA (US); Dawei ZHANG, Saratoga, CA (US); Sigen YE, San Diego, CA (US); Xiang CHEN, Campbell, CA (US); Jie CUI, San Jose, CA (US)

(73) Assignee: Apple Inc., Cupertino, CA (US)

(21) Appl. No.: 19/474,343

(22) PCT Filed: May 9, 2023
(86) PCT No.: PCT/CN2023/093071

§ 371 Date: Oct. 10, 2025

(51) Int. Cl. H04W 52/32; H04B 7/06; H04L 5/00; H04L 27/26

(52) U.S. Cl. CPC H04W 52/32; H04B 7/0639; H04L 5/0044; H04L 27/261

(57) ABSTRACT

Systems, methods, and apparatuses disclosed herein can support full transmission in a wireless network. These systems, methods, and apparatuses can report one or more full power transmission capabilities to support the full power transmission. These systems, methods, and apparatuses can determine whether the wireless network is capable of supporting the one or more full power transmission capabilities. These systems, methods, and apparatuses can be configured in accordance with the one or more full power transmission capabilities when the wireless network is capable of supporting the one or more full power transmission capabilities. Otherwise, these systems, methods, and apparatuses can downgrade the one or more full power transmission capabilities when the wireless network is not capable of supporting the one or more full power transmission capabilities. Thereafter, these systems, methods, and apparatuses can be configured in accordance with the one or more downgraded full power transmission capabilities.

### BACKGROUND

A wireless network can be compliant with a fifth generation technology standard for broadband cellular networks, often referred to as simply 5G, that is developed by an industry consortium, namely, the 3rd Generation Partnership Project (3GPP). Because 5G is an evolving standard, 3GPP uses a system of parallel Releases that provides a stable platform for the implementation of features that allows for new functionality in subsequent Releases.

### SUMMARY OF DISCLOSURE

Some embodiments of this disclosure describe a method for supporting full power transmission within a wireless network. The method includes receiving full power transmission capabilities reported by a user equipment (UE) within the wireless network, each full power transmission capability from among the full power transmission capabilities including a corresponding full power transmission mode selected from among full power transmission modes and a corresponding maximum number of transmitter (Tx) uplinks (ULs) that the UE is capable of supporting in the corresponding full power transmission mode; identifying full power transmission configurations based on the full power transmission capabilities, each full power transmission configuration from among the full power transmission configurations including the corresponding full power transmission mode and a corresponding supported number of Tx ULs selected from among the corresponding maximum number of Tx ULs that the AN is capable of supporting for the corresponding full power transmission mode; and providing the full power transmission configurations to configure the UE to operate in the full power transmission.

In some embodiments, the receiving can include receiving the full power transmission capabilities on UL Control Information (UCI) on a Physical UL Control Channel (PUCCH), UL Media Access Control-Control Element (MAC-CE) on Physical UL Shared Channel (PUSCH), or Radio Resource Control (RRC) message on the PUSCH. In these embodiments, the providing can include transmitting the full power transmission configuration on Downlink Control Information (DCI) on a Physical Downlink Control Channel (PDCCH), Downlink (DL) MAC-CE on Physical Downlink Shared Channel (PDSCH), or the RRC message on the PDSCH.

In some embodiments, the full power transmission modes can include a full power transmission mode 0, a full power transmission mode 1, and a full power transmission mode 2 as outlined in a Release of a fifth generation (5G) technology standard. In these embodiments, the corresponding maximum number of Tx ULs can include two Tx ULs, four Tx ULs, or eight Tx ULs.

In some embodiments, when the corresponding full power transmission mode includes the full power transmission mode 1, each full power transmission capability from among the full power transmission capabilities can further include a Transmit Precoding Matrix Indicator (TPMI) that can support the full power transmission from among one or more lists of TPMIs that stored in the AN.

In some embodiments, when the corresponding full power transmission mode includes the full power transmission mode 2, each full power transmission capability from among the full power transmission capabilities can further include a maximum number of Sounding Reference Signal (SRS)-Resources that supports the full power transmission in an SRS-ResourceSet, a maximum number of SRS ports, or a list of number of SRS ports that supports the full power transmission in the SRS-ResourceSet.

In some embodiments, the identifying can include comparing the corresponding maximum number of Tx ULs for each of the full power transmission capabilities with a number of Tx ULs that is supported by the AN and downgrading the corresponding maximum number of Tx ULs for a corresponding full power transmission capability from among full power transmission capabilities that is not supported by the AN to provide the corresponding supported number of Tx ULs.

In some embodiments, each full power transmission capability from among the full power transmission capabilities can further include a corresponding coherency mode selected from among coherency modes. In these embodiments, the coherency modes can include non-coherent, partial-coherent, or full-coherent.

Some embodiments of this disclosure describe an access node (AN) having a transceiver and a processor. The transceiver can enable wireless communication with a user equipment (UE) in a wireless network. The processor can receive, using the transceiver, one or more full power transmission capabilities reported by the UE, each full power transmission capability from among the full power transmission capabilities can include a corresponding full power transmission mode selected from among full power transmission modes and a corresponding maximum number of transmitter (Tx) uplinks (ULs) that the UE is capable of supporting in the corresponding full power transmission mode, identify full power transmission configurations based on the full power transmission capabilities, each full power transmission configuration from among the full power transmission configurations can include the corresponding full power transmission mode and a corresponding supported number of Tx ULs selected from among the corresponding maximum number of Tx ULs that the AN is capable of supporting for the corresponding full power transmission mode, and provide the full power transmission configurations to configure the UE to operate in the full power transmission.

In some embodiments, the transceiver can receive the full power transmission capabilities on UL Control Information (UCI) on a Physical UL Control Channel (PUCCH), UL Media Access Control-Control Element (MAC-CE) on Physical UL Shared Channel (PUSCH), or Radio Resource Control (RRC) message on the PUSCH. In these embodiments, the providing can include transmitting the full power transmission configuration on Downlink Control Information (DCI) on a Physical Downlink Control Channel (PDCCH), Downlink (DL) MAC-CE on Physical Downlink Shared Channel (PDSCH), or the RRC message on the PDSCH.

In some embodiments, the full power transmission modes can include a full power transmission mode 0, a full power transmission mode 1, and a full power transmission mode 2 as outlined in a Release of a fifth generation (5G) technology standard. In these embodiments, the corresponding maximum number of Tx ULs can include two Tx ULs, four Tx ULs, or eight Tx ULs.

In some embodiments, when the corresponding full power transmission mode includes the full power transmission mode 1, each full power transmission capability from among the full power transmission capabilities can further include a Transmit Precoding Matrix Indicator (TPMI) that can support the full power transmission from among one or more lists of TPMIs that stored in the AN.

In some embodiments, when the corresponding full power transmission mode includes the full power transmission mode 2, each full power transmission capability from among the full power transmission capabilities can further include a maximum number of Sounding Reference Signal (SRS)-Resources that supports the full power transmission in an SRS-ResourceSet, a maximum number of SRS ports, or a list of number of SRS ports that supports the full power transmission in the SRS-ResourceSet.

In some embodiments, the processor can compare the corresponding maximum number of Tx ULs for each of the full power transmission capabilities with a number of Tx ULs that is supported by the AN and can downgrade the corresponding maximum number of Tx ULs for a corresponding full power transmission capability from among full power transmission capabilities that is not supported by the AN to provide the corresponding supported number of Tx ULs.

In some embodiments, each full power transmission capability from among the full power transmission capabilities can further include a corresponding coherency mode selected from among coherency modes. In these embodiments, the coherency modes can include non-coherent, partial-coherent, or full-coherent.

Some embodiments of this disclosure describe an access node (AN) having a memory and a processor. The memory can store full power transmission capabilities reported by a user equipment (UE) within the wireless network, each full power transmission capability from among the full power transmission capabilities can include a corresponding full power transmission mode selected from among full power transmission modes and a corresponding maximum number of transmitter (Tx) uplinks (ULs) that the UE is capable of supporting in the corresponding full power transmission mode. The processor can execute instructions stored in the memory, the instructions, when executed by the processor, configuring the processor to: identify full power transmission configurations based on the full power transmission capabilities, each full power transmission configuration from among the full power transmission configurations can include the corresponding full power transmission mode and a corresponding supported number of Tx ULs selected from among the corresponding maximum number of Tx ULs that the AN is capable of supporting for the corresponding full power transmission mode, and provide the full power transmission configurations to configure the UE to operate in the full power transmission.

In some embodiments, the full power transmission modes can include a full power transmission mode 0, a full power transmission mode 1, and a full power transmission mode 2 as outlined in a Release of a fifth generation (5G) technology standard. In these embodiments, the corresponding maximum number of Tx ULs can include two Tx ULs, four Tx ULs, or eight Tx ULs.

In some embodiments, the instructions, when executed by the processor, can configure the processor to compare the corresponding maximum number of Tx ULs for each of the full power transmission capabilities with a number of Tx ULs that is supported by the AN and downgrade the corresponding maximum number of Tx ULs for a corresponding full power transmission capability from among full power transmission capabilities that is not supported by the AN to provide the corresponding supported number of Tx ULs.

In some embodiments, each full power transmission capability from among the full power transmission capabilities can further include a corresponding coherency mode selected from among the coherency modes.

This Summary is provided merely for purposes of illustrating some embodiments to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the disclosure and, together with the description, further serve to explain the principles of the disclosure and enable a person of skill in the relevant art(s) to make and use the disclosure.

FIG. 1 graphically illustrates an exemplary wireless network that supports full power transmission in accordance with various embodiments of the present disclosure.

FIG. 2 illustrates a flowchart of an exemplary operation of the exemplary wireless network in accordance with various embodiments of the present disclosure.

FIG. 3 illustrates a block diagram of an electronic device that supports full power transmission in accordance with various embodiments of the present disclosure.

FIG. 4 illustrates a block diagram of an exemplary computer system that can be implemented within the exemplary wireless network.

The disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Release 15, often referred to as Rel-15, outlines downlink control information (DCI) that can indicate a Transmit Precoding Matrix Indicator (TPMI) to indicate a precoding matrix and the number of layers that should be used by a transmitter, such as a User Equipment (UE), to send uplink (UL) data to a receiver, such as an access node (AN), over an uplink data channel, such as Physical Uplink Shared Channel (PUSCH). However, a UE cannot arbitrarily indicate the precoding matrix to support full power transmission mode. Full power mode, full power transmission, full power transmission mode, or the like represents a feature developed by 3GPP that enables certain UEs to operate at their maximum performance level, for example, to transmit more power in the UL by using all their power amplifiers at their disposal. In Rel-15, if the precoder matrix selected by the AN in the TPMI does not use all of the UE ports, then the full power transmission mode is not supported. Release 16, often referred to as Rel-16, conditionally supports the full power transmission mode for coherent, non-coherent or partial-coherent UEs for a maximum of four transmitter (Tx) ULs. These full power transmission modes include full power transmission mode 0 where all the power amplifiers of the UE can deliver full power, full power transmission mode 1 where not all of the power amplifiers of the UE can deliver full power, and full power transmission mode 2 where not all of the power amplifiers of the UE can deliver full power. Future Releases, such as Release 18, often referred to as Rel-18, are being developed to extend support for these full power transmission modes from the maximum of four Tx ULs as supported by Rel-16 to a maximum of eight Tx ULs. And these future releases are extending coverage of these full power transmission modes for all coherency types, including full coherence, partial coherence, and non-coherent.

### Overview

Systems, methods, and apparatuses disclosed herein can support full transmission in a wireless network. These systems, methods, and apparatuses can report one or more full power transmission capabilities to support the full power transmission. These systems, methods, and apparatuses can determine whether the wireless network is capable of supporting the one or more full power transmission capabilities. These systems, methods, and apparatuses can be configured in accordance with the one or more full power transmission capabilities when the wireless network is capable of supporting the one or more full power transmission capabilities. Otherwise, these systems, methods, and apparatuses can downgrade the one or more full power transmission capabilities when the wireless network is not capable of supporting the one or more full power transmission capabilities. Thereafter, these systems, methods, and apparatuses can be configured in accordance with the one or more downgraded full power transmission capabilities.

### Exemplary Wireless Network That Supports for Full Power Transmission

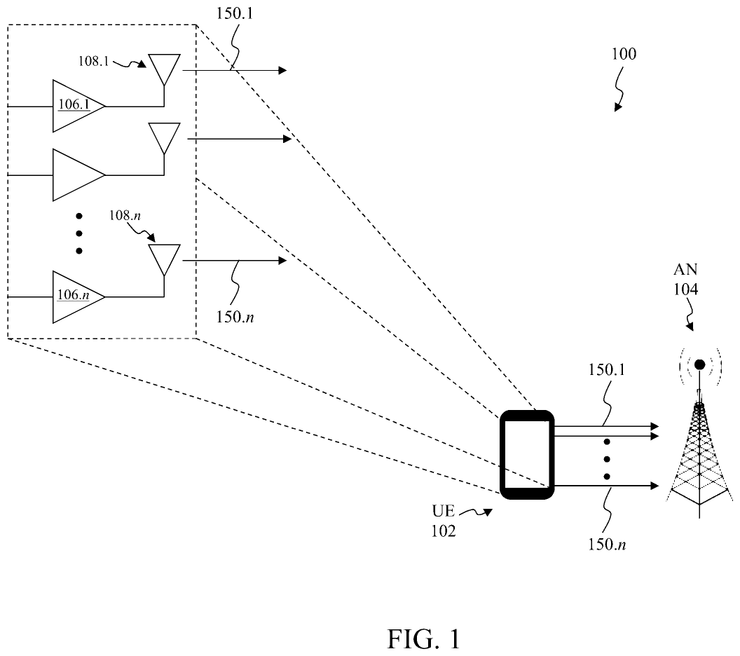

FIG. 1 graphically illustrates an exemplary wireless network that supports full power transmission in accordance with various embodiments of the present disclosure. In the exemplary embodiment illustrated in FIG. 1, a wireless network 100 includes a user equipment (UE) 102 and an access node (AN) 104. As illustrated in FIG. 1, the AN 104 can transmit downlink (DL) data over a DL to the UE 102. As used herein, the terms downlink, DL, or the like refer to a first direction from the AN 104 to the UE 102 to provide an example. The DL can include one or more downlink communication channels, for example, a Physical Downlink Control Channel (PDCCH) and/or a Physical Downlink Shared Channel (PDSCH). And as illustrated in FIG. 1, the AN 104 can receive uplink (UL) data over an UL from the UE 102. As used herein, the terms UL, or the like refers to a second direction from the UE 102 to the AN 104 to provide an example. The UL can include one or more uplink communication channels, for example, a Physical Uplink Control Channel (PUCCH) and/or a Physical Uplink Shared Channel (PUSCH). As illustrated in FIG. 1, the UL can include multiple transmitter (Tx) uplinks (ULs) 150.1 through 150.n to transit the UL data over the UL to the AN 104. As to be described in further detail below, the UE 102 and the AN 104 can functionally cooperate to provide full power transmission over the multiple Tx ULs 150.1 through 150.n. As to be described in further detail below, the UE 102 can report one or more full power transmission capabilities to support the full power transmission over the multiple Tx ULs 150.1 through 150.n to the AN 104. And as further detailed below, the AN 104 can evaluate the one or more full power transmission capabilities reported by the UE 102 to determine one or more full power transmission configurations for the UE 102 to support the full power transmission over the multiple Tx ULs 150.1 through 150.n.

The wireless network 100 can be configured to operate based on a wide variety of wireless communication techniques. These techniques can include, but are not limited to, techniques based on 3rd Generation Partnership Project (3GPP) standards. In some embodiments, the UE 102 can include one or more consumer electronics devices, one or more cellular phones, one or more smartphones, one or more feature phones, one or more tablet computers, one or more wearable computer devices, one or more personal digital assistants (PDAs), one or more pagers, one or more wireless handsets, one or more desktop computers, one or more laptop computers, one or more in-vehicle infotainments (IVIs), one or more in-car entertainment (ICEs) devices, one or more Instrument Clusters (ICs), one or more head-up display (HUD) devices, one or more onboard diagnostic (OBD) devices, one or more dashtop mobile equipments (DMEs), one or more mobile data terminals (MDTs), one or more Electronic Engine Management Systems (EEMSs), one or more electronic/engine control units (ECUs), one or more electronic/engine control modules (ECMs), one or more embedded systems, one or more microcontrollers, one or more control modules, one or more engine management systems (EMSs), one or more networked or “smart” appliances, one or more Machine-Type-Communication (MTC) devices, one or more Machine-to-Machine (M2M) devices, one or more Internet of Things (IoT) devices, and the like. In these embodiments, the UE 102 can be configured to operate based on a wide variety of wireless communication techniques such as, but not limited to, techniques based on 3GPP standards. For example, the UE 102, and the AN 104 can be configured to operate using Rel-15, Rel-16, Rel-17, Rel-18, or others. And in some embodiments, the AN 104 can include one or more Next Generation Node BSs (gNBs), one or more radio access nodes (RANs), one or more evolved NodeBs (eNBs), one or more NodeBs, one or more Roadside Units (RSUs), one or more Transmission Reception Points (TRxPs or TRPs), and/or the like. In these embodiments, the AN 104 can include one or more nodes configured to operate based on a wide variety of wireless communication techniques such as, but not limited to, techniques based on 3GPP standards. For example, the AN 104 can include one or more nodes configured to operate using Rel-15, Rel-16, Rel-17, Rel-18, or others.

### Exemplary Support for the Full Power Transmission

The discussion to follow is to describe functional cooperation between the UE 102 and the AN 104 to provide full power transmission over the multiple Tx ULs 150.1 through 150.n. Although the discussion to follow is to be described in terms of a maximum of eight Tx ULs, those skilled in the relevant art(s) will recognize that the discussion to follow can be similarly implemented to support full power transmission for a maximum of more or less Tx ULs without departing from the spirit and scope of the present disclosure. Although Rel-18 is being developed to extend support for the full power transmission to the maximum of eight Tx ULs as described above, those skilled in the relevant art(s) will recognize that the teachings herein are equally applicable to other Releases that can support different maximums of Tx ULs without departing from the spirit and scope of the present disclosure.

### Exemplary Reporting of Full Power Transmission Capabilities by an Exemplary User Equipment

In the exemplary embodiment illustrated in FIG. 1, the UE 102 can report the one or more full power transmission capabilities of the UE 102 to support the full power transmission. In some embodiments, the UE 102 can report the one or more full power transmission capabilities to the AN 104 on Layer 1 signaling, such as Uplink Control Information (UCI) on a Physical Uplink Control Channel (PUCCH), Layer 2 signaling, for example, UL Media Access Control-Control Element (MAC-CE) on Physical Uplink Shared Channel (PUSCH), or Layer 3 signaling, for example, Radio Resource Control (RRC) message on PUSCH. In some embodiments, the one or more full power transmission capabilities can indicate plurality of full power transmission modes that are supported by the UE 102, for example, the full power transmission mode 0, the full power transmission mode 1, and/or the full power transmission mode 2. In some embodiments, the one or more full power transmission capabilities can further indicate a maximum number of Tx ULs that are capable of supporting these full power transmission modes, for example, two Tx ULs, four Tx ULs, and/or eight Tx ULs. In some embodiments, the one or more full power transmission capabilities can further indicate a coherency mode, for example, non-coherent, partial-coherent, and/or full-coherent, that is supported by the UE 102, and/or any other suitable capability of the UE 102 to support the full power transmission as will be recognized by those skilled in the relevant art(s) without departing from the spirit and scope of the present disclosure. In some embodiments, the other suitable capability of the UE 102 can include one or more TPMIs from among one or more lists of TPMIs stored in the AN 104 that can support the full power transmission, a maximum number of Sounding Reference Signal (SRS)-Resources that can support the full power transmission in a SRS-ResourceSet with usage equal to “codebook,” a maximum number of SRS ports, and/or a list of number of SRS ports that can support the full power transmission in the SRS-ResourceSet with usage equal “codebook” to provide some examples. In these embodiments, the other suitable capability of the UE 102 is often needed to be reported by the UE 102 to support full power transmission mode 1 and/or the full power transmission mode 2. In some embodiments, the one or more full power transmission capabilities can indicate all of the plurality of full power transmission modes that are supported by the UE 102, for example, the full power transmission mode 0, the full power transmission mode 1, and/or the full power transmission mode 2, and a maximum number of Tx ULs that are capable of supporting each of these full power transmission modes, for example, two Tx ULs, four Tx ULs, and/or eight Tx ULs. Alternatively, or in addition to, the one or more full power transmission capabilities can indicate a single full power transmission mode from among the plurality of full power transmission modes that is supported by the UE 102, for example, the full power transmission mode 0, the full power transmission mode 1, and/or the full power transmission mode 2, and a maximum number of Tx ULs that are capable of supporting the single full power transmission mode, for example, two Tx ULs, four Tx ULs, and/or eight Tx ULs.

As described above, the other suitable capability of the UE 102 can include the one or more TPMIs from among one or more lists of TPMIs stored in the AN 104 that can support the full power transmission. Generally, the one or more TPMIs can be selected by the UE 102 from among the one or more lists of TPMIs stored in the AN 104 for the full power transmission based upon the coherency mode, for example non-coherent, partial-coherent, and/or full-coherent. When operating in the non-coherent mode, the UE 102 can select a single coherent TPMI from among the one or more lists of TPMIs stored in the AN 104 for the full power transmission. In some embodiments, the single coherent TPMI can be characterized as including non-zero power for every SRS port. When operating in the partial-coherent mode, the UE 102 can select one or more coherent TPMIs from among the one or more lists of TPMIs stored in the AN 104 for the full power transmission. In some embodiments, the maximum number of Tx ULs that are capable of supporting the full power transmission can be divided in multiple antenna groups, for example, eight Tx ULs can be divided into two—four Tx UL groups or four—two Tx UL groups to provide some examples, with antennas within the same antenna group being coherent. In these embodiments, the one or more coherent TPMIs can cover coherent operation in each of the multiple antenna groups. In some embodiments, the UE 102 can report the one or more TPMIs with different granularity to effectively reduce the overhead associated with reporting the one or more full power transmission capabilities to the AN 104. In these embodiments, the UE 102 can report one or more lists of the TPMIs with coarse granularity followed by selecting and reporting the one or more TPMIs from among the one or more lists of TPMIs with finer granularity, for example, by reporting one or more indices that are associated with the one or more TPMIs. In terms of reporting granularity, from coarse to fine, the one or more TPMIs can be reported per UE, per band combination (BC), per band, per feature set (FS), and/or per feature set per carrier (FSPC).

In some embodiments, the one or more full power transmission capabilities can indicate the plurality of full power transmission modes that are supported by the UE 102, for example, the full power transmission mode 0, the full power transmission mode 1, and/or the full power transmission mode 2, that are supported in each of the coherency modes, for example, non-coherent, partial-coherent, and/or full-coherent. Alternatively, or in addition to, the one or more full power transmission capabilities can indicate a single full power transmission mode from among the plurality of full power transmission modes that is supported by the UE 102, for example, the full power transmission mode 0, the full power transmission mode 1, and/or the full power transmission mode 2, that is supported in by a single coherency mode, for example, non-coherent, partial-coherent, and/or full-coherent. In this alternate, or addition, the AN 104 can assume the single full power transmission mode is similarly supported by any lesser category coherency mode. In some embodiments, the full-coherent mode represents the greatest category coherency mode and the non-coherent represents the least category coherency mode. As such, the full-coherent coherence can be effectively downgraded to the non-coherent mode or the partial-coherent mode and/or partial-coherent mode can be effectively downgraded to the non-coherent mode by the AN 104 as to be described in further detail below.

As illustrated in FIG. 1, the UE 102 can include n-power amplifiers 106.1 through 106.n coupled to corresponding antennas from among n-antennas 108.1 through 108.n. In some embodiments, the UE 102 can report support for the full power transmission mode 0 over a maximum of m Tx ULs, for example, two Tx ULs, four Tx ULs, and/or eight Tx ULs, from among the n Tx ULs when m-power amplifiers 106.1 through 106.m from among the n-power amplifiers 106.1 through 106.m are capable of delivering full power. In some embodiments, the UE 102 can report support for the full power transmission mode 1 over the maximum of m Tx ULs, from among the n Tx ULs when none of the m-power amplifiers 106.1 through 106.m from among the n-power amplifiers 106.1 through 106.n are capable of delivering full power. In some embodiments, the UE 102 can report support for the full power transmission mode 2 over the maximum of m Tx ULs, from among the n Tx ULs when some of the m-power amplifiers 106.1 through 106.m from among the n-power amplifiers 106.1 through 106.m are capable of delivering full power. In some embodiments, the full power that the UE 102 is capable of delivering can be outlined by a Power Class category that defines a maximum transmit power for the UE 102 over, for example, channel bandwidth. In some embodiments, the UE Power Class category can include Power Class 1 (PC1) having a maximum transmit power of 31 decibel-milliwatts (dBm), Power Class 2 (PC2) having a maximum transmit power of 26 dBm, Power Class 3 (PC3) having a maximum transmit power 23 dBm, among others. In some embodiments, the UE 102 can identify the m-power amplifiers 106.1 through 106.m from among the n-power amplifiers 106.1 through 106.n that are capable of delivering full power and/or k-power amplifiers 106.1 through 106.k from among the n-power amplifiers 106.1 through 106.n that are not capable of delivering full power. Thereafter, the UE 102 can report the one or more full power transmission capabilities of the UE 102 to support the full power transmission in terms of the m-power amplifiers and/or the n-power amplifiers.

As an example, the UE 102 including eight power amplifiers can be associated with the Power Class category PC3 having maximum transmit power of {23 dBm, 23 dBm, 23 dBm, 23 dBm, 23 dBm, 23 dBm, 23 dBm, 23 dBm}. In this example, the UE 102 can report its capability to support the full power transmission mode 0 with eight power amplifiers capable of delivering full power of 23 dBm as outlined by the Power Class category PC3 for a maximum of eight Tx ULs. As another example, the UE 102 including eight power amplifiers can be associated with the Power Class category PC3 having maximum transmit power of {23 dBm, 23 dBm, 23 dBm, 23 dBm, 20 dBm, 20 dBm, 20 dBm, 20 dBm}. In this other example, the UE 102 can report its capability to support the full power transmission mode 0 with four power amplifiers capable of delivering full power of 23 dBm as outlined by the Power Class category PC3 for a maximum of four Tx ULs and/or its capability to support the full power transmission mode 1 with eight power amplifiers capable of delivering less than full power of 23 dBm as outlined by the Power Class category PC3 for a maximum of eight Tx ULs. As a further example, the UE 102 including eight power amplifiers can be associated with the Power Class category PC3 having maximum transmit power of {23 dBm, 23 dBm, 20 dBm, 20 dBm, 20 dBm, 20 dBm, 20 dBm, 20 dBm}. In this further example, the UE 102 can report its capability to support the full power transmission mode 0 with two power amplifiers capable of delivering full power of 23 dBm as outlined by the Power Class category PC3 for a maximum of two Tx ULs, its capability to support the full power transmission mode 1 with four power amplifiers capable delivering less than full power of 23 dBm as outlined by the Power Class category PC3 for a maximum of four Tx ULs, and/or its capability to support the full power transmission mode 2 with some of the eight power amplifiers capable delivering full power of 23 dBm as outlined by the Power Class category PC3 at 23 dBm for a maximum of eight Tx ULs.

### Exemplary Determining of Full Power Transmission Configurations for the Exemplary User Equipment by an Exemplary Access Node

In some embodiments, the AN 104 can access the one or more full power transmission capabilities reported by the UE 102. In these embodiments, the AN 104 can receive the one or more full power transmission capabilities reported by the UE 102 on the Layer 1 signaling, such as UCI on the PUCCH, the Layer 2 signaling, for example, UL MAC-CE on the PUSCH, or the Layer 3 signaling, for example, RRC message on the PUSCH. In the exemplary embodiment illustrated in FIG. 1, the AN 104 can evaluate the one or more full power transmission capabilities reported by the UE 102 to identify one or more full power transmission configurations for the UE 102 that are supported by the wireless network 100. In some embodiments, the AN 104 can provide the one or more full power transmission configurations to the UE 102 on Layer 1 signaling, such as Downlink Control Information (DCI) on a Physical Downlink Control Channel (PDCCH), Layer 2 signaling, for example, downlink (DL) Media Access Control-Control Element (MAC-CE) on Physical Downlink Shared Channel (PDSCH), or Layer 3 signaling, for example, RRC message on the PDSCH. In some embodiments, the one or more full power configurations can indicate the full power transmission mode to be used by the UE 102, for example, the full power transmission mode 0, the full power transmission mode 1, and/or the full power transmission mode 2, as reported in the one or more full power transmission capabilities. In some embodiments, the one or more full power transmission configurations can further indicate supported number of Tx ULs selected from among the maximum number of Tx ULs that the AN 104 is capable of supporting for these full power transmission modes, for example, two Tx ULs, four Tx ULs, and/or eight Tx ULs. In some embodiments, the one or more full power transmission capabilities can further indicate the coherency mode, for example, non-coherent, partial-coherent, and/or full-coherent, to be used by the UE 102 as reported in the one or more full power transmission capabilities and/or any other suitable capability to be used by the UE 102 as reported in the one or more full power transmission capabilities as will be recognized by those skilled in the relevant art(s) without departing from the spirit and scope of the present disclosure. Alternatively, or in addition to, the one or more full power configurations for the UE 102 can indicate that the UE 102 is to operate in less than the full power transmission mode as reported in the one or more full power transmission capabilities, with less than the number of Tx ULs as reported in the one or more full power transmission capabilities, with a lesser category coherency mode as reported in the one or more full power transmission capabilities, and/or with less the other suitable capability of the UE 102 as reported in the one or more full power transmission capabilities as will be recognized by those skilled in the relevant art(s) without departing from the spirit and scope of the present disclosure.

In some embodiments, the AN 104 can identify the one or more full power transmission configurations based on the one or more full power transmission capabilities. As part of this identifying, the AN 104 can evaluate, for example, compare, the one or more full power transmission capabilities reported by the UE 102 and one or more capabilities for the full power transmission that are utilized by the wireless network 100 to determine the one or more full power transmission configurations for the UE 102. In some embodiments, wireless communication devices within the wireless network 100, for example, the AN 104, might not have the capabilities to support the one or more full power transmission capabilities reported by the UE 102, for example, the eight Tx ULs. In these embodiments, the AN 104 can effectively downgrade the one or more full power transmission capabilities reported by the UE 102 to be less than the one or more full power transmission capabilities reported by the UE 102 that are supported by the wireless network 100, for example, two Tx ULs or four Tx ULs, to the one or more full power transmission configurations for the UE 102. In these embodiments, the AN 104 can compare each of the one or more full power transmission capabilities reported by the UE 102 and the one or more capabilities for the full power transmission that are the wireless network 100 and can downgrade those full power transmission capabilities from among the one or more full power transmission capabilities that the wireless network 100 is not capable of supporting.

For example, the AN 104 might not be capable of receiving UL data over the eight Tx ULs as reported in the one or more full power transmission capabilities by the UE 102. In this example, the AN 104 can downgrade eight Tx ULs as reported in the one or more full power transmission capabilities by the UE 102 to be the two Tx ULs or the four Tx ULs in the one or more full power configurations. As another example, the one or more full power transmission capabilities reported by the UE 102 can indicate that the UE 102 can support a full-coherent mode. In this other example, the AN 104 can assume that the UE 102 can support a non-coherent mode and/or a partial-coherent mode in response to the full-coherent mode being reporting by the UE 102. As such, in this other example, the AN 104 can downgrade the full-coherent mode as reported in the one or more full power transmission capabilities by the UE 102 to be a non-coherent mode and/or a partial-coherent mode in the one or more full power configurations.

As described above, the one or more full power transmission capabilities reported by the UE 102 can include the maximum number of SRS-Resources that can support the full power transmission in an SRS-ResourceSet with usage equal to “codebook.” In some embodiments, the AN 104 can configure multiple SRS-Resources, for example, six or eight, SRS-Resources, in the SRS-ResourceSet that can support the full power transmission. Alternatively, or in addition to, the AN 104 can configure a maximum number of SRS-Resources, for example, a maximum of four SRS-Resources, in the SRS-ResourceSet that can support the full power transmission. And as described above, the one or more full power transmission capabilities reported by the UE 102 can include the maximum number of SRS ports or a list of number of SRS ports that can support the full power transmission in the SRS-ResourceSet with usage equal “codebook.” In some embodiments, the AN 104 can configure different SRS-Resources in the SRS-ResourceSet with different number of SRS ports. In these embodiments, the AN 104 can configure at most an integer number, for example, two, SRS-Resources in the SRS-ResourceSet with the same amount of SRS ports. Alternatively, the AN 104 can configure more than the integer number, for example, two, SRS-Resources in the SRS-ResourceSet with the same amount of SRS ports.

In some embodiments, for example, the full power transmission mode 2 over the eight Tx ULs, the AN 104 can configure a different number of SRS ports for different SRS-Resources in the same SRS-ResourceSet in terms of PUSCH power scaling of the SRS ports. In these embodiments, for example, when two SRS ports or four SRS ports are used for scheduling, the AN 104 can implement a first type of PUSCH power scaling behavior and/or a second types of PUSCH power scaling behavior. In the first type of PUSCH, the power scaling factor represents a ratio of a number of antenna ports with non-zero PUSCH transmission power over a number of SRS ports or is always one. In the second type of PUSCH power scaling behavior, the power scaling factor varies or is always one. In some embodiments, if the one or more TPMIs reported by the UE 102 support full power transmission, then is power scaling factor is 1. Otherwise, the power scaling factor is the ratio of a number of antenna ports with non-zero PUSCH transmission power over the number of SRS ports.

### Exemplary Operation of the Exemplary Wireless Network

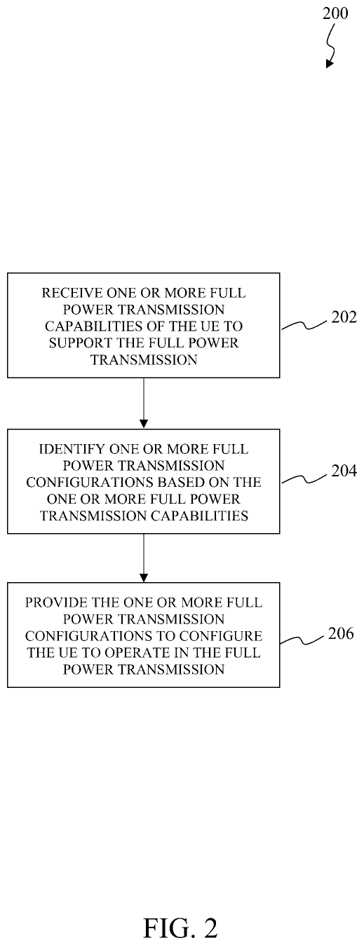

FIG. 2 illustrates a flowchart of an exemplary operation of the exemplary wireless network in accordance with various embodiments of the present disclosure. The disclosure is not limited to this operational description. Rather, it will be apparent to ordinary persons skilled in the relevant art(s) that other operational control flows are within the scope and spirit of the present disclosure. The following discussion describes an exemplary operational control flow 200 for supporting full power transmission within the exemplary wireless network as described above. The operational control flow 200 can be executed by an electronic device, such as the AN 104 as described above.

At operation 202, the operational control flow 200 receives one or more full power transmission capabilities of a UE, such as the UE 102 as described above, to support the full power transmission as described above. In some embodiments, the one or more full power transmission capabilities can indicate plurality of full power transmission modes that are supported by the UE, a maximum number of transmitter (Tx) uplinks (ULs) that are capable of supporting these full power transmission modes, a coherency mode, and/or any other suitable capability of the UE to support the full power transmission as will be recognized by those skilled in the relevant art(s) without departing from the spirit and scope of the present disclosure as described above. In some embodiments, the other suitable capability of the UE can include one or more TPMIs from among one or more lists of TPMIs stored in the AN that can support the full power transmission, a maximum number of SRS-Resources that can support the full power transmission in a SRS-ResourceSet with usage equal to “codebook,” a maximum number of SRS ports, and/or a list of number of SRS ports that the UE can support the full power transmission in the SRS-ResourceSet with usage equal “codebook” to provide some examples. In some embodiments, operational control flow 200 can receive the one or more full power transmission capabilities on Layer 1 signaling, such as Uplink Control Information (UCI) on a Physical Uplink Control Channel (PUCCH), Layer 2 signaling, for example, uplink (UL) Media Access Control-Control Element (MAC-CE) on Physical Uplink Shared Channel (PUSCH), or Layer 3 signaling, for example, Radio Resource Control (RRC) message on the PUSCH.

At operation 204, the operational control flow 200 identifies one or more full power transmission configurations that are supported by an access node (AN), such as the AN 104, based on the full power transmission capabilities from operation 202. In some embodiments, the one or more full power configurations can indicate the full power transmission mode to be used by the UE, for example, the full power transmission mode 0, the full power transmission mode 1, and/or the full power transmission mode 2, as reported in the one or more full power transmission capabilities from operation 202. In some embodiments, the one or more one or more full power transmission configurations can further indicate a supported number of Tx ULs selected from among the corresponding maximum number of Tx ULs that the AN 104 is capable of supporting for these full power transmission modes, for example, two Tx ULs, four Tx ULs, and/or eight Tx ULs. In some embodiments, the one or more full power transmission capabilities can further indicate the coherency mode, for example, non-coherent, partial-coherent, and/or full-coherent, to be used by the UE as reported in the one or more full power transmission capabilities from operation 202 and/or any other suitable capability to be used by the UE in the one or more full power transmission capabilities as will be recognized by those skilled in the relevant art(s) without departing from the spirit and scope of the present disclosure. In some embodiments, the operational control flow 200 can, as part of this identifying, compare the corresponding maximum number of Tx ULs for each of the one or more full power transmission capabilities from operation 202 with a number of Tx ULs that is supported by the AN and/or downgrade the corresponding maximum number of Tx ULs for a corresponding full power transmission capability from the full power transmission capabilities from operation 202 that is not supported by the AN to provide the corresponding supported number of Tx ULs.

At operation 206, the operational control flow 200 provides the one or more full power transmission configurations from operation 204 to the UE so as to configure the UE from operation 202 to operate in the full power transmission. In some embodiments, the operational control flow 200 can provide the one or more full power transmission capabilities received in operation 202 as one or more one or more full power transmission configurations to the UE from operation 202 on Layer 1 signaling, such as Downlink Control Information (DCI) on a Physical Downlink Control Channel (PDCCH), Layer 2 signaling, for example, downlink (DL) Media Access Control-Control Element (MAC-CE) on Physical Downlink Shared Channel (PDSCH), or Layer 3 signaling, for example, RRC message on the PDSCH.

### Exemplary Electronic Device That Can Be Implemented Within the Exemplary Wireless Networks

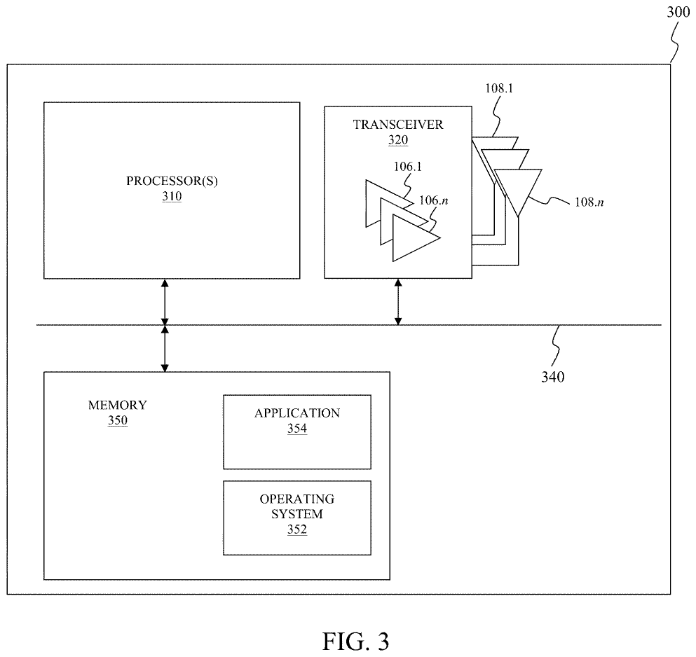

FIG. 3 illustrates a block diagram of an electronic device that supports full power transmission in accordance with various embodiments of the present disclosure. In the exemplary embodiment illustrated in FIG. 3, an electronic device 300 may be any of the electronic devices, for example, the UE 102 and/or the AN 104 as illustrated in FIG. 1. As illustrated in FIG. 3, the electronic device includes one or more processors 310, one or more transceivers 320, a communication infrastructure 340, a memory 350, an operating system 352, an application 354, and the n-antennas 108.1 through 108n. The various systems illustrated in FIG. 3 are provided as exemplary parts of the electronic device 300, and the electronic device 300 can include other circuit(s) and subsystem(s). Also, although the systems of the electronic device 300 are illustrated as separate components, the aspects of this disclosure can include any combination of these, less, or more components. Also, the electronic device 300 can include any number of processors, transceivers, communication infrastructures, memories, operating systems, applications, and antennas.

The memory 350 may include random access memory (RAM) and/or cache, and may include control logic (e.g., computer software) and/or data. The memory 350 may include other storage devices or memory such as, but not limited to, a hard disk drive and/or a removable storage device/unit. According to some examples, the operating system 352 can be stored in the memory 350. The operating system 352 can manage transfer of data between the memory 350, the application 354, the processor 310, and/or the transceiver 320. In some examples, the operating system 352 maintains one or more network protocol stacks (e.g., Internet protocol stack, cellular protocol stack, and the like) that can include a number of logical layers. At corresponding layers of the protocol stack, the operating system 352 includes control mechanism and data structures to perform the functions associated with that layer. In some embodiments, the application 354 can be stored in the memory 350. The application 354 can include applications (e.g., user applications) used by a wireless electronic device and/or a user of the wireless electronic device. The application 354 can include applications such as, but not limited to, radio streaming, video streaming, remote control, and/or other user applications.

The electronic device 300 can also include the communication infrastructure 340. The communication infrastructure 340 provides communication between, for example, the processor 310, the transceiver 320, and the memory 350. In some implementations, the communication infrastructure 340 may be a bus. The processor 310 together with instructions stored in memory 350 can performs operations enabling the electronic device 300 to supports full power transmission as described above in FIG. 1 and/or FIG. 2.

The transceiver 320 can transmit and receive communications signals that support the operations of electronic device including according to some aspects, and may be coupled to the n-antennas 108.1 through 108.n. In some embodiments, the transceiver 320 can include the n-power amplifiers 106.1 through 106.n as described above that are coupled to the n-antennas 108.1 through 108.n. The n-antennas 108.1 through 108.n may include one or more antennas that may be the same or different types. The transceiver 320 allows the electronic device 300 to communicate with other devices that may be wired and/or wireless. In some examples, the transceiver 320 can include processors, controllers, radios, sockets, plugs, buffers, and like circuits/devices used for connecting to and communication on networks.

According to some examples, the transceiver 320 include one or more circuits to connect to and communicate on wired and/or wireless networks. In some embodiments, the transceiver 320 can include a cellular subsystem, a WLAN subsystem, and/or a Bluetooth™ subsystem, each including its own radio transceiver and protocol(s) as will be understood by those skilled arts based on the discussion provided herein. In some implementations, the transceiver 320 can include more or fewer systems for communicating with other devices. In some embodiments, the transceiver 320 can include one or more circuits (including a WLAN transceiver) to enable connection(s) and communication over WLAN networks such as, but not limited to, networks based on standards described in IEEE 802.11. Additionally, or alternatively, the transceiver 320 can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 320n can include a Bluetooth™ transceiver. In some embodiments, the transceiver 320 can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), New Radio (NR) and the like. For example, the transceiver 320a-530n can be configured to operate according to one or more of Rel-15, Rel-16, Rel-17, Rel-18, or any other of the 3GPP standards.

In some embodiments, the processor 310, alone or in combination with computer instructions stored within the memory 350, and/or the transceiver 320 can support full power transmission as described above in FIG. 1 and/or FIG. 2.

### Exemplary Computer System That Can Be Implemented Within the Exemplary Wireless Network

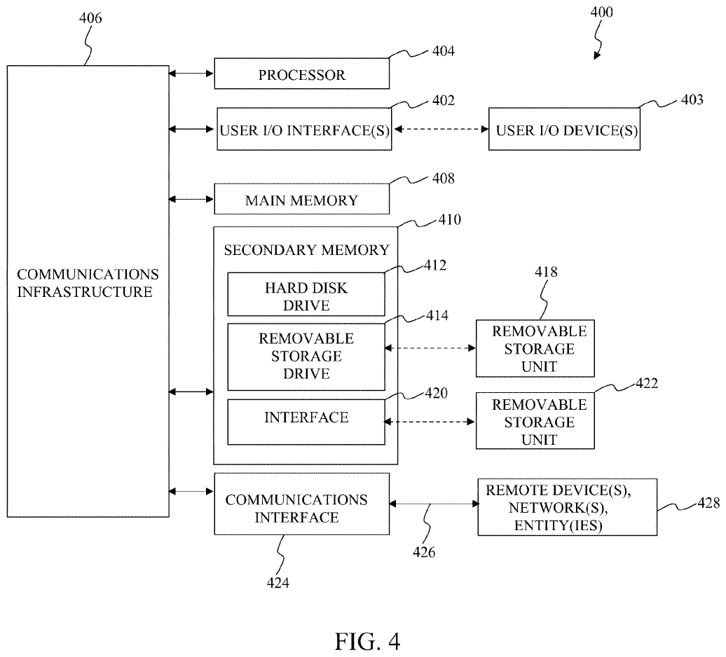

FIG. 4 illustrates a block diagram of an exemplary computer system that can be implemented within the exemplary wireless network according to some exemplary embodiments of the present disclosure. Computer system 400 can be any well-known computer capable of performing the functions described herein such as the UE 102 and/or the AN 104 as described above. Computer system 400 includes one or more processors (also called central processing units, or CPUs), such as a processor 404. Processor 404 is connected to a communication infrastructure 406 (e.g., a bus). Computer system 400 also includes user input/output device(s) 403, such as monitors, keyboards, pointing devices, etc., that communicate with communication infrastructure 406 through user input/output interface(s) 402. Computer system 400 also includes a main or primary memory 408, such as random access memory (RAM). Main memory 408 may include one or more levels of cache. Main memory 408 has stored therein control logic (e.g., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to some aspects, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 400, main memory 408, secondary memory 410 and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 4. In particular, aspects may operate with software, hardware, and/or operating system implementations other than those described herein.

### Conclusion

Embodiments of the disclosure can be implemented in hardware, firmware, software application, or any combination thereof. Embodiments of the disclosure can also be implemented as instructions stored on one or more computer-readable mediums, which can be read and executed by one or more processors. A computer-readable medium can include any mechanism for storing or transmitting information in a form readable by a computer (e.g., a computing circuitry). For example, a computer-readable medium can include non-transitory computer-readable mediums such as read only memory (ROM); random access memory (RAM); magnetic disk storage media; optical storage media; flash memory devices; and others. As another example, the computer-readable medium can include transitory computer-readable medium such as electrical, optical, acoustical, or other forms of propagated signals (e.g., carrier waves, infrared signals, digital signals, etc.). Further, firmware, software application, routines, instructions have been described as performing certain actions. However, it should be appreciated that such descriptions are merely for convenience and that such actions in fact result from computing devices, processors, controllers, or other devices executing the firmware, software application, routines, instructions, etc.

It is to be appreciated that the Detailed Description section, and not the Summary and Abstract sections, is intended to be used to interpret the claims. The Summary and Abstract sections may set forth one or more but not all exemplary embodiments of the disclosure as contemplated by the inventor(s), and thus, are not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan considering the teachings and guidance.

The breadth and scope of the disclosure should not be limited by any of the above-described exemplary embodiments but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A method for supporting full power transmission within a wireless network, the method comprising:
receiving, by an access node (AN) within the wireless network, one or more full power transmission capabilities reported by a user equipment (UE) within the wireless network, each full power transmission capability from among the one or more full power transmission capabilities including a corresponding full power transmission mode selected from among a plurality of full power transmission modes and a corresponding maximum number of transmitter (Tx) uplinks (ULs) that the UE is capable of supporting in the corresponding full power transmission mode;
identifying, by the AN, one or more full power transmission configurations based on the one or more full power transmission capabilities, each full power transmission configuration from among the one or more full power transmission configurations including the corresponding full power transmission mode and a corresponding supported number of Tx ULs selected from among the corresponding maximum number of Tx ULs that the AN is capable of supporting for the corresponding full power transmission mode; and
providing, by the AN, the one or more full power transmission configurations to the UE to configure the UE to operate in the full power transmission.

2. The method of claim 1, wherein the receiving comprises receiving the one or more full power transmission capabilities on UL Control Information (UCI) on a Physical UL Control Channel (PUCCH), UL Media Access Control-Control Element (MAC-CE) on Physical UL Shared Channel (PUSCH), or Radio Resource Control (RRC) message on the PUSCH, and
wherein the providing comprises transmitting the full power transmission configuration on Downlink Control Information (DCI) on a Physical Downlink Control Channel (PDCCH), Downlink (DL) MAC-CE on Physical Downlink Shared Channel (PDSCH), or the RRC message on the PDSCH.

3. The method of claim 1, wherein the plurality of full power transmission modes comprises a full power transmission mode 0, a full power transmission mode 1, and a full power transmission mode 2 as outlined in a Release of a fifth generation (5G) technology standard, and
wherein the corresponding maximum number of Tx ULs comprises two Tx ULs, four Tx ULs, or eight Tx ULs.

4. The method of claim 1, wherein, when the corresponding full power transmission mode comprises the full power transmission mode 1, each full power transmission capability further includes a Transmit Precoding Matrix Indicator (TPMI) that supports the full power transmission from among one or more lists of TPMIs that are stored in the AN.

5. The method of claim 1, wherein, when the corresponding full power transmission mode comprises the full power transmission mode 2, each full power transmission capability from among the one or more full power transmission capabilities further includes a maximum number of Sounding Reference Signal (SRS)-Resources that support the full power transmission in an SRS-ResourceSet, a maximum number of SRS ports, or a list of number of SRS ports that support the full power transmission in the SRS-ResourceSet.

6. The method of claim 1, wherein the identifying comprises:
comparing the corresponding maximum number of Tx ULs for each of the one or more full power transmission capabilities with a number of Tx ULs that is supported by the AN; and
downgrading the corresponding maximum number of Tx ULs for a corresponding full power transmission capability from among the one or more full power transmission capabilities that is not supported by the AN to provide the corresponding supported number of Tx ULs.

7. The method of claim 1, wherein each full power transmission capability from among the one or more full power transmission capabilities further includes a corresponding coherency mode selected from among a plurality of coherency modes.

8. The method of claim 7, wherein the plurality of coherency modes comprises non-coherent, partial-coherent, or full-coherent.

9. An access node (AN), comprising:
a transceiver configured to enable wireless communication with a user equipment (UE) in a wireless network; and
a processor configured to:
receive, using the transceiver, one or more full power transmission capabilities reported by the UE, each full power transmission capability from among the one or more full power transmission capabilities including a corresponding full power transmission mode selected from among a plurality of full power transmission modes and a corresponding maximum number of transmitter (Tx) uplinks (ULs) that the UE is capable of supporting in the corresponding full power transmission mode,
identify one or more full power transmission configurations based on the one or more full power transmission capabilities, each full power transmission configuration from among the one or more full power transmission configurations including the corresponding full power transmission mode and a corresponding supported number of Tx ULs selected from among the corresponding maximum number of Tx ULs that the AN is capable of supporting for the corresponding full power transmission mode, and
provide the one or more full power transmission configurations to configure the UE to operate in the full power transmission.

10. The AN of claim 9, wherein the transceiver is configured to:
receive the one or more full power transmission capabilities on UL Control Information (UCI) on a Physical UL Control Channel (PUCCH), UL Media Access Control-Control Element (MAC-CE) on Physical UL Shared Channel (PUSCH), or Radio Resource Control (RRC) message on the PUSCH, and
transmit the full power transmission configuration on Downlink Control Information (DCI) on a Physical Downlink Control Channel (PDCCH), Downlink (DL) MAC-CE on Physical Downlink Shared Channel (PDSCH), or the RRC message on the PDSCH.

11. The AN of claim 9, wherein the plurality of full power transmission modes comprises a full power transmission mode 0, a full power transmission mode 1, and a full power transmission mode 2 as outlined in a Release of a fifth generation (5G) technology standard, and
wherein the corresponding maximum number of Tx ULs comprises two Tx ULs, four Tx ULs, or eight Tx ULs.

12. The AN of claim 9, wherein, when the corresponding full power transmission mode comprises the full power transmission mode 1, each full power transmission capability from among the one or more full power transmission capabilities further includes a Transmit Precoding Matrix Indicator (TPMI) that supports the full power transmission from among one or more lists of TPMIs that are stored in the AN.

13. The AN of claim 9, wherein, when the corresponding full power transmission mode comprises the full power transmission mode 2, each full power transmission capability from among the one or more full power transmission capabilities further includes a maximum number of Sounding Reference Signal (SRS)-Resources that supports the full power transmission in an SRS-ResourceSet, a maximum number of SRS ports, or a list of number of SRS ports that supports the full power transmission in the SRS-ResourceSet.

14. The AN of claim 9, wherein the processor is configured to:
compare the corresponding maximum number of Tx ULs for each of the one or more full power transmission capabilities with a number of Tx ULs that is supported by the AN; and
downgrade the corresponding maximum number of Tx ULs for a corresponding full power transmission capability from among the one or more full power transmission capabilities that is not supported by the AN to provide the corresponding supported number of Tx ULs.

15. The AN of claim 9, wherein each full power transmission capability from among the one or more full power transmission capabilities further includes a corresponding coherency mode selected from among a plurality of coherency modes.

16. The AN of claim 15, wherein the plurality of coherency modes comprises non-coherent, partial-coherent, or full-coherent.

17. An access node (AN), comprising:
a memory that stores one or more full power transmission capabilities reported by a user equipment (UE) within the wireless network, each full power transmission capability from among the one or more full power transmission capabilities including a corresponding full power transmission mode selected from among a plurality of full power transmission modes and a corresponding maximum number of transmitter (Tx) uplinks (ULs) that the UE is capable of supporting in the corresponding full power transmission mode; and
a processor configured to execute instructions stored in the memory, the instructions, when executed by the processor, configuring the processor to:
identify one or more full power transmission configurations based on the one or more full power transmission capabilities, each full power transmission configuration from among the one or more full power transmission configurations including the corresponding full power transmission mode and a corresponding supported number of Tx ULs selected from among the corresponding maximum number of Tx ULs that the AN is capable of supporting for the corresponding full power transmission mode, and
provide the one or more full power transmission configurations to configure the UE to operate in the full power transmission.

18. The AN of claim 17, wherein the plurality of full power transmission modes comprises a full power transmission mode 0, a full power transmission mode 1, and a full power transmission mode 2 as outlined in a Release of a fifth generation (5G) technology standard, and
wherein the corresponding maximum number of Tx ULs comprises two Tx ULs, four Tx ULs, or eight Tx ULs.

19. The AN of claim 17, wherein the instructions, when executed by the processor, configure the processor to:
compare the corresponding maximum number of Tx ULs for each of the one or more full power transmission capabilities with a number of Tx ULs that is supported by the AN; and
downgrade the corresponding maximum number of Tx ULs for a corresponding full power transmission capability from among the one or more full power transmission capabilities that is not supported by the AN to provide the corresponding supported number of Tx ULs.

20. The AN of claim 17, wherein each full power transmission capability from among the one or more full power transmission capabilities further includes a corresponding coherency mode selected from among a plurality of coherency modes.
